(19) United States
(12) Patent Application Publication
(10) Pub. No.: US 2004/0014236 A1
(43) Pub. Date: Jan. 22, 2004

(54) Frequency feedback for NMR magnet temperature control

(76) Inventors: Dror Albo, Tirat Hacarmel (IL); Tal Cohen, Herzlia (IL); Uri Rapoport, D.N. Merkaz (IL)

Correspondence Address: FOLEY HOAG, LLP, PATENT GROUP, WORLD TRADE CENTER WEST, 155 SEAPORT BLVD, BOSTON, MA, 02110, US

(21) Appl. No.: 10/200,644

(22) Filed: Jul. 22, 2002

(51) Int. Cl. G01N 24/00

(52) U.S. Cl. 436/173

(57) ABSTRACT

Methods and systems to control the temperature of a source of a fixed or permanent magnetic field used in Nuclear Magnetic Resonance (NMR) by sensing, measuring, or otherwise detecting the differences in the resonant or Larmor frequency, and based on the difference in the resonant or Larmor frequency, changing the temperature of the source of the fixed magnetic field. The temperature change can thus be based on the frequency change and the characteristics of the source (e.g., permanent and/or fixed magnet(s)), including the temperature coefficient of the source.

### FIELD

The device relates to nuclear magnetic resonance (NMR) testing apparatus and more particularly to temperature control of NMR magnets.

### BACKGROUND

Atomic nuclei with an odd number of neutrons (negatively charged) or protons (positively charged), and these spinning nuclei create micro-magnetic fields such that a nucleus can resemble a bar magnet (e.g., magnetic moment) with the north and south poles along the axis of spin. Because nuclei are typically oriented randomly, there is generally not a net magnetic field, but when the nuclei are exposed to a strong and uniform external magnetic field, the nuclei can assemble or align with the field to create a detectable magnetic field. The aligned magnetic moments precess about the axis of the field at a frequency dependent on the strength of the applied magnetic field and on the characteristics of the nuclei.

The spin frequency can be expressed as a product of the applied magnetic field strength and a gyromagnetic constant that is specific to the nuclear species, where such product can otherwise be known as the Larmor frequency. Because the gyromagnetic constant is species-specific, specific nuclei under a given magnetic field will spin at a predictable frequency. Accordingly, when the applied magnetic field changes, the spin frequency for the specific nuclei changes.

When a radio frequency (RF) electromagnetic wave at the Larmor frequency is applied to the atomic nuclei, the atomic nuclei absorb energy from the RF wave and enter an excitation state known as resonance. Discontinuation of the RF wave causes the atoms to relax to the equilibrium state and release the absorbed energy as RF emissions, where appropriate sensors can detect such emissions. Such emissions can be referred to as the free induction relay (FID). The FID can otherwise be understood as the energy release or relaxation rate of the nuclei.

Accordingly, NMR can be performed using a spectrometer that can include a probe for accepting the sample. The probe can be positioned between poles of a fixed or permanent magnet or other device for providing a first magnetic field that is a fixed magnetic field. The sample can additionally be exposed to a second pulsed magnetic field that can be accomplished by, for example, subjecting the sample to RF electromagnetic pulses. RF coils and tuning circuitry associated with the probe can create the second pulsed magnetic field that rotates the net magnetization of the sample nucleus. These RF coils can also detect or measure the FID.

When the RF coil pulses the sample nucleus at the Larmor frequency, the emitted signals can provide a spectrum having a recognizable maximum and/or otherwise providing a signature that can be compared to spectrums for reference samples, for example, to assist in identifying the sample. NMR thus has various applications, including, for example, determining the constituents of the sample.

An exemplary NMR probe is disclosed in U.S. Pat. No. 5,371,464 (Rapoport), incorporated by reference herein in its entirety.

Generally, NMR includes locking to or otherwise maintaining the RF excitation frequency at the resonant frequency for the sample nucleus. Because the nuclear resonant frequency is linearly related to the magnetic field, changes in the magnetic field can cause changes to the nuclear magnetic frequency (i.e., Larmor frequency). Accordingly, a disadvantage of some NMR systems relates to temperature changes that can affect the magnetic field and/or flux provided by the magnet. For example, the magnet can be heated and/or exposed to increased temperatures due to thermal conductivity between the sample stream and the magnet. Samples at high temperatures are often presented to the probe to allow the sample to remain liquid for analysis and to avoid sample gelling, solidifying, etc. These samples can dissipate heat from within the probe and transfer heat through air in the ambient environment to raise the magnet's temperature. Heat from the sample can also radiate through the ambient environment and conduct through the probe to affect the magnet. Other external sources, such as lighting, etc., can also affect the magnet temperature.

### SUMMARY

Disclosed are methods and systems for controlling the temperature of a magnet or other source of a fixed magnetic field in a nuclear magnetic resonance (NMR) device, where the methods and systems include measuring or detecting a change in the Larmor frequency of a sample presented to the NMR device, and based on the measured or detected change, computing a feedback and/or control to change the temperature of the magnet. The measured change in the frequency can be performed using, for example, a phase detector and/or a phase lock loop. An exemplary mechanism is disclosed in U.S. Pat. No. 5,166,620 to Rapoport, the contents of which are herein incorporated by reference in their entirety. The measured change can thus be derived from a comparison of a transmitted frequency applied to the sample and a received frequency obtained from the sample. The transmitted frequency applied to the sample can otherwise be known as an excitation or exciting frequency, while the received frequency can otherwise be known as a resonant frequency. A RF coil can be used to apply the transmitter or exciting frequency from a local oscillator included in a transmitter, and the RF coil can also measure or detect the resonant frequency and communicate a signal corresponding to the resonant frequency to a receiver.

The control can be based on the comparison of the exciting and resonant frequencies, and other factors including, for example, the temperature coefficient of the at least one source and/or magnet that provides the fixed magnetic field. The control can be provided to, for example, one or more heating devices and/or one or more cooling devices that can be in thermal contact with the source of the fixed magnetic field. In some embodiments, the control can be based on a present, current, or existing temperature of the at least one source. Some embodiments can include a temperature sensor that can sense the temperature of the at least one source.

The control can represent a temperature difference or a relative temperature, while in some embodiments, the control can represent an absolute temperature. The control can be provided to, for example, at least one heat pipe, at least one a pulse tube cooler, at least one heat exchanger coil, at least one fluid flow cooler, and at least one thermoelectric cooler. The control can be a command or other signal that can be digital, analog, and/or can represent a current and/or voltage. The format of the control can thus be based on the at least one heating and/or cooling device.

The measured or detected change can also provide a current and/or a voltage to control a magnetic field provided by at least one shim coil that can be in communication with the at least one magnet. In some embodiments, the same control provided to the at least one heating and/or cooling device can also be provided to at least one shim coil. Additionally and optionally, the detected change can provide a voltage, current, or other signal to control a local oscillator at a transmitter, where the transmitter employs the local oscillator to provide an exciting frequency to an RF coil in communications with the sample, and the local oscillator can be varied based on the change. Similarly, the control to the local oscillator may be the same control as that provided to the at least one heating/cooling device and/or the at least one shim coil.

The disclosed methods and systems thus include a transmitter with a local oscillator for providing an exciting frequency to an RF coil in communications with the sample, and a receiver for determining the resonant frequency of the sample based on the free induction decay of the sample. The receiver can include at least one mixer and at least one phase detector.

Accordingly, disclosed is a system for performing NMR on a sample, where the system includes a source for providing a fixed magnetic field, a transmitter for generating an exciting frequency signal, a Radio Frequency (RF) coil coupled to the transmitter for applying the exciting frequency signal to the sample, a receiver coupled to the RF coil to receive a resonance frequency from the sample, at least one comparator to compute a difference between the exciting frequency and the resonance frequency, and, a temperature controller coupled to the at least one comparator to compute a change in source temperature based on the difference. The source includes at least one fixed magnet, and/or at least one permanent magnet. The temperature controller includes at least one heating device and/or at least one cooling device, where the at least one heating device and the at least one cooling device are in thermal contact with the source. The temperature controller can also include at least one processor. Further, the at least one comparator includes at least one of a phase detector and a phase lock loop.

The disclosed methods and systems also include a NMR apparatus that includes means for applying a permanent magnetic field to a sample, means for exciting the sample nuclei with an excitation frequency signal, means for receiving a resonant frequency from the sample nuclei, means for comparing the excitation frequency and the resonant frequency, and, means for computing a temperature for the permanent magnetic field means based on the comparison of the excitation frequency and the resonant frequency.

### BRIEF DESCRIPTION OF THE DRAWINGS

FIG. 1 is one temperature control system for a NMR probe;

FIG. 2 illustrates another embodiment for a NMR temperature control system; and,

FIG. 3 is a third embodiment for a NMR temperature control system.

### DESCRIPTION

To provide an overall understanding, certain illustrative embodiments will now be described; however, it will be understood by one of ordinary skill in the art that the systems and methods described herein can be adapted and modified to provide systems and methods for other suitable applications and that other additions and modifications can be made without departing from the scope of the systems and methods described herein.

Unless otherwise specified, the illustrated embodiments can be understood as providing exemplary features of varying detail of certain embodiments, and therefore features, components, modules, and/or aspects of the illustrations and unless otherwise provided, can be otherwise combined, separated, interchanged, and/or rearranged without departing from the disclosed systems or methods. Additionally, the shapes and sizes of components are also exemplary and can be altered without affecting the disclosed systems or methods.

The disclosed methods and systems employ changes in the resonant or Larmor frequency to control the temperature of a source of a fixed magnetic field, including for example, a NMR fixed or permanent magnet(s). As will be provided herein, the measured or detected frequency changes can be input to a temperature controller that can control a heating and/or cooling source that is in thermal contact or communications with the source or magnet. The methods and systems can optionally and additionally be used with other systems that use, for example, shim coils or feedback with variable oscillators to otherwise compensate for changes in the magnetic field.

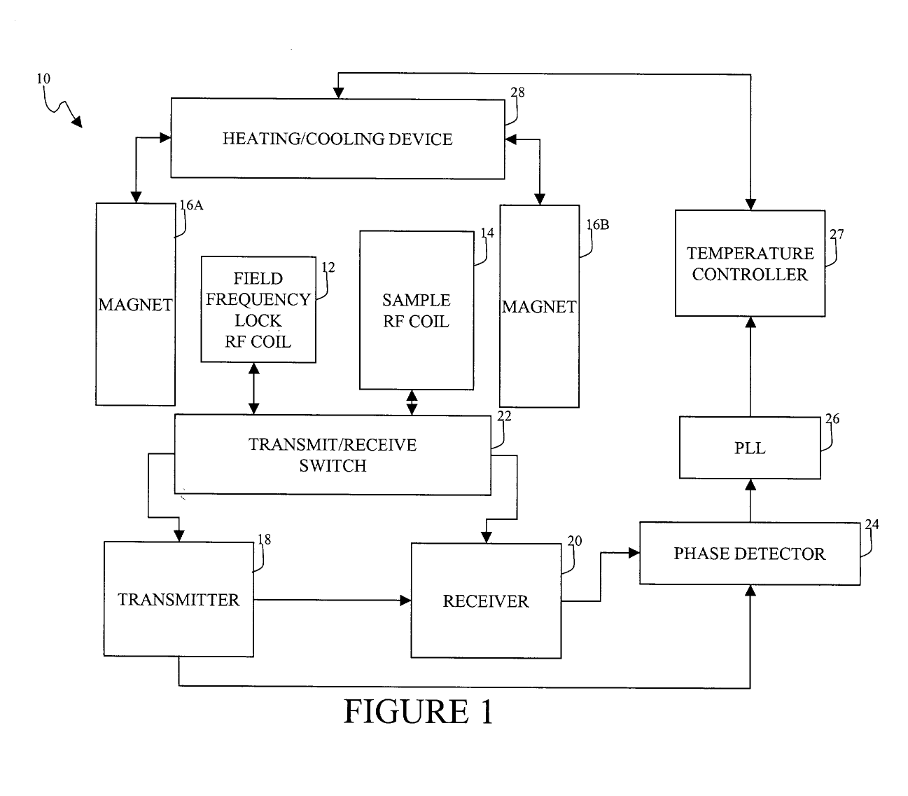

FIG. 1 shows one embodiment 10 for the disclosed methods and systems that includes two RF coils 12, 14 that can be positioned in a fixed magnetic field that can be provided by one or more fixed or permanent magnets 16A, 16B, although those of ordinary skill in the art will recognize that other magnet arrangements can be used and that the disclosed methods and systems are not limited to a method or means for providing a uniform fixed magnetic field, and other sources of providing a fixed and/or uniform magnetic field can be employed. The first RF coil 12 can be known as a field frequency lock RF coil and can be positioned to be in communications with a known substance, and for example, can be positioned around a container that includes a known substance such as deuterium. The second RF coil 14 can be associated with or otherwise in communications with a sample substance to be measured. For example, the second RF coil 14 can be positioned around a container that can enclose or otherwise contain a sample substance. As is known in the art, the RF coils 12, 14 can provide RF pulses to the respective substances (e.g., known substance, sample substance) and the RF coils 12, 14 can similarly sense the Free Induction Decay (FID) of the substances. As is shown in FIG. 1, accordingly, a transmitter 18 and a receiver 20 can be coupled to the RF coils 12, 14 via a transmit/receive switch 22 or another device that can interface the transmitter 18 and receiver 20 to the RF coils 12, 14.

The transmitter 18 can include, for example, a local oscillator and/or one or more other oscillators, and may also include a mixer or other means for combining and/or upconverting the signals from the one or more oscillators. The receiver 20 can similarly include, for example, a RF amplifier, a mixer for downconverting the received RF signal to IF, an IF amplifier and filter, a phase detector, and a low pass filter. Those of ordinary skill in the art will recognize that such components are provided merely for illustration and not limitation, and other exemplary transmitters 18 and receivers 20 can be shown in U.S. Pat. No. 5,166,620, FIGS. 1-12, the contents of which are herein incorporated by reference in their entirety. Those of ordinary skill in the art will also recognize that multiple transmitters and receivers can be used (e.g., one for the field frequency lock, one for the sample), and accordingly, multiple transmit/receive switches 22 can also be used. The embodiments shown herein and including FIG. 1, for example, are merely provided for explanatory and illustrative purposes, and are not intended to be exhaustive of all possible embodiments, or limited to such embodiments.

As shown in the FIG. 1 system, the transmitter 18 can communicate with the receiver 20 and both the transmitter 18 and receiver 20 can thereby provide inputs to a phase detector 24 or other means that can detect phase changes based on comparing the transmitted (e.g, exciting) and received (e.g., resonant) frequencies. The phase detector 24 can provide the phase information to a phase locked loop (PLL) 26 or another mechanism for phase comparison, to provide, for example, a frequency or other comparison measure that can be input to at least a temperature controller 27. In one embodiment, the temperature controller can include at least one processor and instructions for causing the processor to perform as provided herein.

Using the output of the PLL 26, the temperature controller 27 can determine the resonant or Larmor frequency change (e.g., incremental difference and/or absolute difference) and can accordingly compute instructions and/or a control to modify the source temperature accordingly, the source shown in FIG. 1 as a magnet 16A, 16B, and the temperature controller 27 can supply such instructions and/or control to a heating/cooling device 28. The heating/cooling device 28 can be in thermal contact and/or communications with the source, shown as magnets 16A, 16B. Those of ordinary skill in the art will thus recognize that a system according to FIG. 1 can include one or more processors with instructions and can additionally and optionally be implemented with a variety of hardware and software components.

For example, the heating/cooling device 28 and temperature controller 27 can be separate devices or a single device. In one example embodiment, commonly known heat pipes can be used as a single heating, cooling, and sensing device, where such heat pipes can be interfaced to a processor that can be incorporated with the temperature controller 27 or in communications with the temperature controller 27. For the disclosed embodiments, such processor may be equipped with instructions for receiving a control or other signal indicative of a change in frequency, for example, and converting the frequency change to a magnet temperature change. Those with ordinary skill in the art will recognize that although the change in magnet temperature is based on and/or proportional to the detected frequency change, such change in magnet temperature is also based on characteristics of the magnet(s) 16A, 16B or other source of the fixed magnetic field. Accordingly, the temperature controller(s) 27 and/or at least one heating/cooling device(s) 28 can include an input for providing magnet characteristics and/or other data for allowing the computation of the changes in magnetic temperature. Similarly, the temperature controller(s) 27 and/or heating/cooling device(s) 28 can include an input for or otherwise include a means for obtaining the current temperature of the magnet, and additionally and optionally, memory for including, for example, the operating frequency, the previous control and/or change data provided by the PLL 24, and/or other information including one or more previously measured resonant frequencies of the sample. For example, the control can also be based on a difference between a measured or detected resonant frequency at a given time or measurement interval, relative to a measured or detected resonant frequency at a previous time or measurement interval.

It can be understood that the disclosed methods and systems can include a temperature sensor associated with or otherwise in thermal contact or communications with the source (e.g., magnets 16A, 16B), although other embodiments may compute relative temperature measurements without employing the current source or magnet temperature. Some embodiments may compute relative temperatures using the current source or magnet temperature.

In one embodiment, the current data from the PLL 24 can be compared to the previous data from the PLL 24 to provide a difference or relative control or value that can also be incorporated into the computation upon which a source (e.g., magnet) temperature is based. The computed source (e.g., magnet) temperature can be compared to the existing source temperature to compute a difference temperature, and a control signal can be computed based on the difference temperature. In some embodiments, a relative temperature can be computed without employing previous data. Additionally and optionally, in an embodiment, a control or other command or signal including an absolute temperature can be provided to the heating/controlling device(s) 28.

The heating/cooling device(s) 28 can include, for example, a pulse tube cooler(s), one or more heat exchanger coils, a fluid flow cooler(s), a thermoelectric cooler(s) for use with known heat pipe technology, and other devices, with such examples provided for illustration and not limitation. For example, cooling conduits can extend from into and/or about magnets 16A, 16B to enable heat transfer between the conduits and source, illustrated to as magnets 16A, 16B.

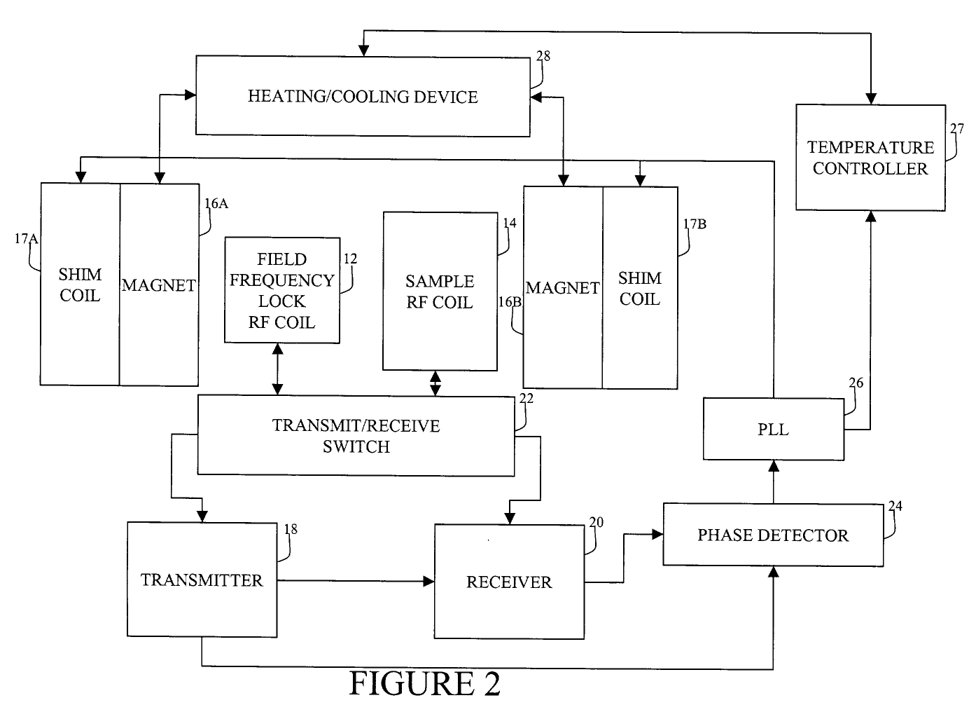

FIG. 2 provides an embodiment according to FIG. 1 where a frequency lock mechanism can be employed by utilizing the changes in resonant or Larmor frequency (i.e., magnetic field) to provide a current or other control to shim coils 17A, 17B, that can be configured in various manners (e.g., wrapped around permanent magnets, etc.), to vary the magnetic field provided by the source 16A, 16B. As FIG. 2 indicates, the methods and systems of FIG. 1 can be similarly implemented in an embodiment according to FIG. 2 that utilizes the shim coils 17A, 17B. In an embodiment such as FIG. 2, the magnetic field applied by the magnets 16A, 16B can thus be altered by the shim coils 17A, 17B and/or the heating/cooling device(s) 28. Generally, the FIG. 2 transmitter 18 includes a fixed oscillator.

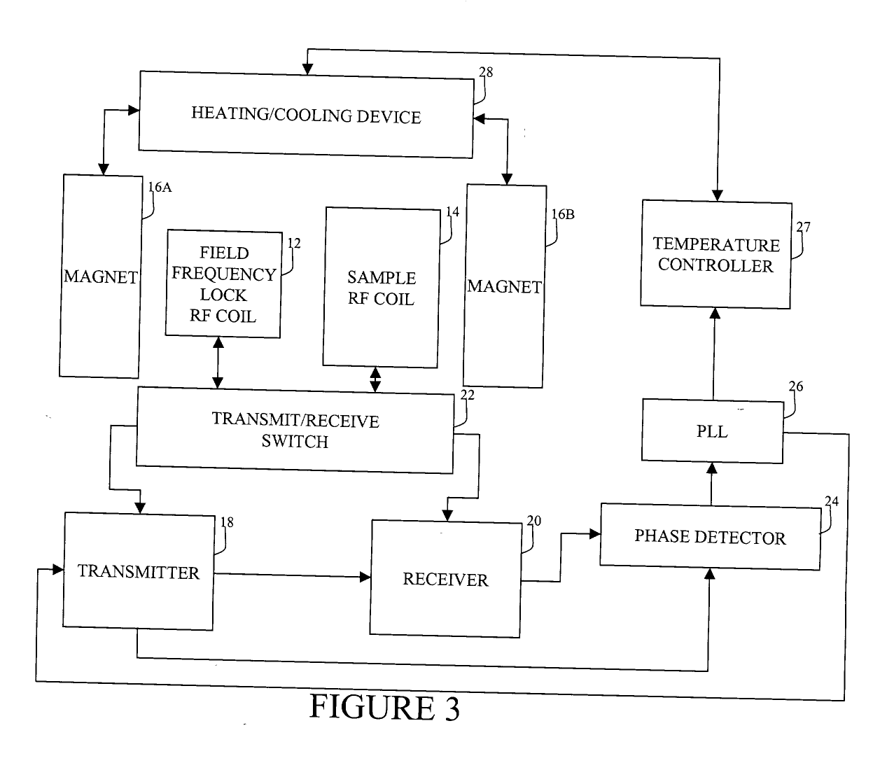

FIG. 3 provides another embodiment where the FIG. 3 transmitter 18 may include a variable oscillator and the FIG. 3 system can employ a frequency lock mechanism such as that provided in U.S. Pat. No. 5,166,620, incorporated herein by reference in its entirety. Based on FIG. 3, the magnetic field provided by the magnets 16A, 16B can be temperature controlled according to the methods and systems of FIG. 1, and additionally, the excitation frequency can be locked to changes in the magnetic field (e.g., Larmor or resonant frequency) by employing a variable transmitter frequency. In such a system, the output from the PLL 26 can be input to the transmitter 18 using, for example, a voltage signal that represents the difference between a local oscillator of the transmitter 18 and the generated resonant frequency of the sample. This same output, or a different output, can also be provided to the temperature controller 27 as provided previously herein with respect to FIG. 1.

What has thus been described are methods and systems to control the temperature of a source of a fixed or permanent magnetic field used in NMR by sensing, measuring, or otherwise detecting the differences in the resonant or Larmor frequency, and based on the difference in the resonant or Larmor frequency, changing the temperature of the source of the fixed magnetic field. The temperature change can thus be based on the frequency change and the characteristics of the source (e.g., permanent and/or fixed magnet(s)), including the temperature coefficient of the source. In some instances, the measured or detected change can be a zero detected change that can result in, for example, no control or command to be provided to a heating/cooling device(s). In other embodiments, a zero detected change can cause a control or command to be provided to a heating cooling device(s) that maintains the temperature at the present temperature.

While the method and systems have been disclosed in connection with the illustrated embodiments, various modifications and improvements thereon will become readily apparent to those skilled in the art. For example, the heating/cooling device can be the same or separate devices for heating and cooling, and can be controlled by the same or different processors. As indicated previously, the temperature controller can be incorporated with the heating and/or cooling device(s), or can interface to the same. The difference frequency and/or phase values and other values provided herein can be expressed as voltage or current, and can be analog or digital signals.

Accordingly, many additional changes in the details, materials, and arrangement of parts, herein described and illustrated, can be made by those skilled in the art. It will thus be understood that the following claims are not to be limited to the embodiments disclosed herein, can include practices otherwise than specifically described, and are to be interpreted as broadly as allowed under the law.

What is claimed is:

1. A method for performing nuclear magnetic resonance (NMR), comprising:
detecting a change in a resonant frequency of a sample presented for NMR, and,
based on the detected change, computing a control to change a temperature of at least one source of a fixed magnetic field.

2. A method according to claim 1, wherein detecting a change includes employing at least one of a phase detector and a phase lock loop.

3. A method according to claim 1, wherein detecting a change includes comparing a transmitted frequency applied to the sample and a received frequency obtained from the sample.

4. A method according to claim 1, wherein detecting a change includes comparing an exciting frequency applied to the sample and a resonant frequency obtained from the sample.

5. A method according to claim 1, wherein computing a control includes determining a temperature coefficient associated with the at least one source.

6. A method according to claim 1, wherein computing a control includes providing the control to at least one of: at least one heating device and at least one cooling device.

7. A method according to claim 1, wherein computing a control includes determining the temperature of the at least one source.

8. A method according to claim 1, wherein computing a control includes computing at least one of a relative temperature and an absolute temperature.

9. A method according to claim 1, further including using the change to control at least one shim coil.

10. A method according to claim 1, further including using the change to control a local oscillator at a transmitter, where such transmitter employs a local oscillator to provide an exciting frequency to an RF coil in communications with the sample, and the local oscillator can be varied to based on the change.

11. A method according to claim 1, further including,
providing a transmitter with a local oscillator for providing an exciting frequency to an RF coil in communications with the sample, and,
providing a receiver for determining a resonant frequency of the sample based on a free induction decay of the sample.

12. A method according to claim 11, wherein the RF coil detects the free induction decay of the sample.

13. A method according to claim 1, wherein the at least one source includes at least one of: at least one permanent magnet and at least one fixed magnet.

14. A method according to claim 1, wherein computing the control includes providing the control to at least one of: at least one heat pipe, at least one a pulse tube cooler, at least one heat exchanger coil, at least one fluid flow cooler, and at least one thermoelectric cooler.

15. A system for performing Nuclear Magnetic Resonance (NMR) on a sample, the system comprising:
a source for providing a fixed magnetic field,
a transmitter for generating an exciting frequency signal,
a Radio Frequency (RF) coil coupled to the transmitter for applying the exciting frequency signal to the sample,
a receiver coupled to the RF coil to receive a resonance frequency from the sample,
at least one comparator to compute a difference frequency between the exciting frequency and the resonance frequency, and,
a temperature controller coupled to the at least one comparator to compute a change in source temperature based on the difference frequency.

16. A system according to claim 15, wherein the source includes at least one of: at least one fixed magnet, and at least one permanent magnet.

17. A system according to claim 15, wherein the temperature controller includes at least one of:
at least one heating device, and,
at least one cooling device,
where the at least one heating device and the at least one cooling device are in thermal contact with the source.

18. A system according to claim 15, wherein the temperature controller includes at least one of: at least one heat pipe, at least one a pulse tube cooler, at least one heat exchanger coil, at least one fluid flow cooler, and at least one thermoelectric cooler.

19. A system according to claim 15, wherein the temperature controller includes at least one processor.

20. A system according to claim 15, where the at least one comparator includes at least one of a phase detector and a phase lock loop.

21. A system according to claim 15, further including a field frequency RF coil in communications with the transmitter and the receiver.

22. A system according to claim 15, wherein the transmitter includes at least one of a mixer and a local oscillator.

23. A system according to claim 15, further including shim coils in communication with the source.

24. A system according to claim 19, wherein the shim coils are in communications with the at least one comparator.

25. A system according to claim 15, where the transmitter is in communications with the at least one comparator.

26. A Nuclear Magnetic Resonance (NMR) apparatus comprising:
means for applying a permanent magnetic field to a sample,
means for exciting the sample nuclei with an excitation frequency signal,
means for receiving a resonant frequency from the sample nuclei,
means for comparing the excitation frequency and the resonant frequency, and,
means for computing a temperature for the permanent magnetic field means based on the comparison of the excitation frequency and the resonant frequency.

27. An apparatus according to claim 26, wherein means for applying a permanent magnetic field to a sample include at least one of: at least one permanent magnet and at least one fixed magnet.

28. An apparatus according to claim 26, further comprising means for controlling the means for applying a permanent magnetic field based on the computed temperature.

29. An apparatus according to claim 26, wherein the means for exciting the sample nuclei include at least one of a transmitter and a RF coil, where the transmitter includes a local oscillator.

30. An apparatus according to claim 26, wherein the means for comparing includes at least one of a phase detector and a phase lock loop.

31. An apparatus according to claim 26, wherein the means for computing includes at least one processor.

32. A method for controlling the temperature of a source of a fixed magnetic field, the method comprising:
measuring a change in a resonant frequency of a sample exposed to the source, and,
based on the change in the resonant frequency of the sample, providing a control to change the temperature of the source.

33. A method according to claim 32, wherein the source is at least one of: at least one fixed magnet and at least one permanent magnet.

34. A method according to claim 32, wherein providing a control includes providing a control to at least one of: at least one heating and at least one cooling device.

35. A method according to claim 34, wherein the at least one heating device and the at least one cooling device are in thermal contact with the source.

36. A method according to claim 32, wherein measuring a change in resonant frequency includes comparing a difference between an exciting frequency and a resonant frequency.
